(19) United States
(12) Patent Application Publication
(10) Pub. No.: US 2008/0303404 A1
(43) Pub. Date: Dec. 11, 2008

(54) PLASMA DISPLAY PANEL

(76) Inventors: Yoshimi Kawanami, Miyazaki (JP); Nobuyuki Hori, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/038,083

(22) Filed: Feb. 27, 2008

(30) Foreign Application Priority Data
Jun. 7, 2007 (JP) 2007-151985

(51) Int. Cl. H01J 1/63

(52) U.S. Cl. 313/489

(57) ABSTRACT

A transmission type PDP having a contrast enhanced by reducing or preventing influences of diffuse reflection by a phosphor layer is described. This PDP includes: a first substrate structure (rear unit) having a pair of display electrodes formed thereto; a second substrate structure (front unit) having an address electrode formed thereto and having a display surface; a barrier rib; and a phosphor layer between the barrier ribs. A width of the address electrode is formed to be the same as or larger than a width of a bottom surface portion of the phosphor layer between the barrier ribs, thereby hiding the bottom portion of the phosphor by the address electrode. In this manner, the diffuse reflection at the bottom surface portion of the phosphor layer is mostly suppressed.

### CROSS-REFERENCE TO RELATED APPLICATION

The present application claims priority from Japanese Patent Application No. JP 2007-151985 filed on Jun. 7, 2007, the content of which is hereby incorporated by reference into this application.

### TECHNICAL FIELD OF THE INVENTION

The Present invention relates to plasma display panels (PDP) and the display devices thereof (plasma display devices: PDP devices), and in particular, it relates to a transmission type PDP.

### BACKGROUND OF THE INVENTION

For an AC (alternating current drive) type PDP device, as a way of using the light emission from phosphors by discharge, a transmission type has been considered in the early stages. However, since this type has been regarded to be insufficient in terms of the light emission efficiency, the structure of a current reflection type has become mainstream. Note that, here, the transmission type means a type whose front unit side having a display surface has an address electrode (denoted by A), a phosphor, and so forth arranged thereto, and whose rear unit side has a display electrode arranged thereto. The reflection type means the opposite of the transmission type. The display electrode is a sustain electrode (denoted by X), a scanning electrode (denoted by Y), and the like used for discharge (sustain discharge) in a display period.

However, also in recent years, some studies on the modification of the transmission-type PDP have been made. As for a three-electrode/transmission-type PDP, there are those disclosed in Japanese Patent Application Laid-Open Publication No. 2004-356063 and Japanese Patent Application Laid-Open Publication No. 2004-14372. As for a four-electrode/transmission-type PDP, there is the one disclosed in Japanese Patent No. 3437596.

As for a technique of a polarizing element provided to a front surface of a panel for suppressing the reflection of the external light, there is, for example, the one disclosed in Japanese Patent Application Laid-Open Publication No. 2003-227933.

### SUMMARY OF THE INVENTION

With respect to the conventional transmission-type PDP, there has been room for consideration/improvement in various points such as emission efficiency. Particularly, the diffuse reflection of the panel is mainly generated by phosphors (particularly a bottom surface portion), and there is a problem that the contrast is lowered due to the diffuse reflection by the phosphors. Set performance of the panel (performance when adjusting the black luminance to be constant by an optical filter of the panel front surface) is affected by the luminous efficiency (taken as A) of the panel and the diffuse reflectance (taken as B) of the panel, and when the diffuse reflectance (B) of the panel is large, the set performance is lowered. An evaluation index of the set performance is A/√B.

The present invention has been made in view of the above mentioned problems, and an object of the invention is mainly to reduce or prevent the influence of the diffuse reflection by the phosphor in the technique of PDP so that the contrast is improved and the set performance of the panel is enhanced.

The typical ones of the inventions disclosed in this application will be briefly described as follows. To achieve the abovementioned object, the present invention has the following configurations based on a transmission-type PDP. First, the present PDP (transmission-type PDP) is a plasma display panel comprising a first and a second substrate structures sandwiching a discharge space for encapsulating a discharge gas, in which a display cell group is configured by an electrode group, in which the first substrate structure (rear unit) includes a display electrode (X, Y) pair extending in a first direction to a first glass substrate and the second substrate structure (front unit) includes an address electrode (A) extending in a second direction to a second glass substrate, and in which the first substrate structure is arranged on a rear surface side, and the second substrate structure is arranged on a front surface side. Note that, for purposes of description, in the present PDP, the front unit side is referred to as a second substrate structure and the rear unit side is referred to as a first substrate structure.

Further, the second substrate structure includes barrier ribs formed by extending at least in the second direction so as to divide the discharge space and phosphors (phosphor layers) of respective colors formed between the barrier ribs and exposed in the discharge space. The barrier rib is, for example, formed to the substrate of the front unit by sandblasting and the like. The phosphor layer includes a bottom surface portion formed on a surface (for example, a surface of a second dielectric layer) corresponding to an address electrode of the front unit (second glass substrate) side between the barrier ribs. In addition, for example, the barrier rib is made translucent so that the luminous efficiency of the panel (transmission-type PDP) is increased.

The present PDP has configurations of, for example, the following (1) to (3) corresponding to the reduction of the influence of the diffuse reflection by the phosphor.

(1) In the present PDP, as a main feature, the display cell and the like are configured such that the phosphor (particularly bottom surface portion) between the barrier ribs is hidden by the address electrode when seen from the front surface (display surface) side of the panel. In other words, the panel has a configuration where a width (d1) of the phosphor (bottom surface portion) between the barrier ribs and a width (d2) of the address electrode have a relationship of d1≦d2. Consequently, the diffuse reflection by the phosphor (bottom surface portion) is reduced or prevented by being blocked by the address electrode. Therefore, a diffuse reflection factor (B) of the panel becomes small (the panel becomes substantially specular reflective), thereby improving the contrast.

(1A) For example, by making a width (d1) of the bottom surface portion of the phosphor between the barrier ribs and a width (d2) of the address electrode nearly the same, the phosphor (bottom surface portion) is hidden by the address electrode (d1≈d2) when seen from the front surface side.

(1B) For example, by making the width (d2) of the address electrode larger than the width (d1) of the bottom surface portion of the phosphor between the barrier ribs, not only the bottom surface portion of the phosphor but also an end portion (side) of the side surface of the barrier rib are hidden by the address electrode (d1<d2). As a result, the unevenness on the display surface due to the barrier rib (unevenness of the formation) is reduced or prevented.

(1C) Further, corresponding to a position directly below the address electrode (center), particularly, corresponding to a region (address discharge position) where the address electrode and the scanning electrode cross with each other, a configuration is adopted where a part of the bottom surface of the phosphor portion is not provided, in other words, a void portion is provided. As a result, the electric discharge using the address electrode is easy to generate.

(2) In another PDP, to make the phosphor between the barrier ribs not visible when seen from the front surface side, a configuration is adapted where the phosphor (bottom surface portion) is not provided to the surface (such as second dielectric layer) between barrier ribs of a second substrate structure (second glass substrate) side. For example, it is a configuration where the phosphor (side surface portion of the phosphor) is provided to only the side surface of the barrier rib. It does not matter if the width (d2) of the address electrode is smaller than the width (d1) of the bottom surface portion of the phosphor. As a result, similarly to the above item (1), the diffuse reflection by the phosphor can be prevented.

(3) Still further, in the above items (1) and (2), a configuration (3A) where a polarizing element for suppressing the reflection of the outside light and/or a configuration (3B) where a near-infrared-ray shielding or absorbing layer is not provided are/is adopted to the front surface side of the panel (substantially specular reflective). In the above panels of the items (1) and (2), a diffuse reflection component by the phosphor is few or dwindles to almost nothing, and the outside light reflection is mainly based on a specular reflective component, and has a property of being polarization-preserved. Further, the panels of the above items (1) and (2) have properties of near-infrared-ray shielding (absorption) by an action in the discharge space. By using these properties, the configurations of the above items (3A) and (3B) and the like are made. The polarizing element includes a linear polarization layer and a quarter circular polarization layer.

Moreover, particularly, as a part of a directly-attached filter (film filter), the abovesaid polarizing element is provided on the front surface of the panel. According to the above item (3A), the contrast is improved. According to the above item (3B), the abovesaid function is realized without providing the shielding/absorbing layer to the filter.

The effects obtained by typical aspects of the present invention will be briefly described below. According to the present invention, in the technique of the PDP, mainly by reducing or preventing the influence of the diffuse reflection by the phosphor, the contrast can be enhanced and the set performance of the panel can be increased.

### BRIEF DESCRIPTIONS OF THE DRAWINGS

FIG. 1 is a diagram showing a basic schematic configuration of a PDP according to the present invention;

FIG. 2 is a diagram showing a part (corresponding to a display cell) of a cross section (x-z plane) along a lateral direction of a PDP of a first embodiment (configuration 1A) according to the present invention;

FIG. 3 is a diagram showing a part (corresponding to a display cell) of a schematic structure of a plane viewed from a front surface side of the PDP of the first embodiment (configuration 1A) according to the present invention;

FIG. 4 is a diagram showing a part (corresponding to a display cell) of a cross section (x-z plane) along a lateral direction of a PDP of a second embodiment (configuration 1B) according to the present invention;

FIG. 5 is a diagram showing a part (corresponding to a display cell) of a schematic structure of a plane viewed from a front surface side of the PDP of the second embodiment (configuration 1B) according to the present invention;

FIG. 6 is a diagram showing a part (corresponding to a display cell) of a cross section (x-z plane) along a lateral direction of a PDP of a third embodiment (configuration 1C) according to the present invention;

FIG. 7 is a diagram showing a part (corresponding to a display cell) of a cross section (x-z plane) along a lateral direction of a PDP of a fourth embodiment according to the present invention;

FIG. 8 is a diagram showing a part (corresponding to a display cell) of a cross section (x-z plane) along a lateral direction of a PDP of a fifth embodiment according to the present invention; and

FIG. 9 is a diagram showing a part (corresponding to a display cell) of a schematic structure of a plane viewed from a front surface side of the PDP of an example of a conventional art.

### DESCRIPTIONS OF THE PREFERRED EMBODIMENTS

Hereinafter, first to fifth embodiments of the present invention will be described in detail with reference to the accompanying drawings. Note that components having the same function are denoted by the same reference symbols throughout the drawings for describing the first to fifth embodiment, and the repetitive description thereof will be omitted.

### First Embodiment (Configuration 1A)

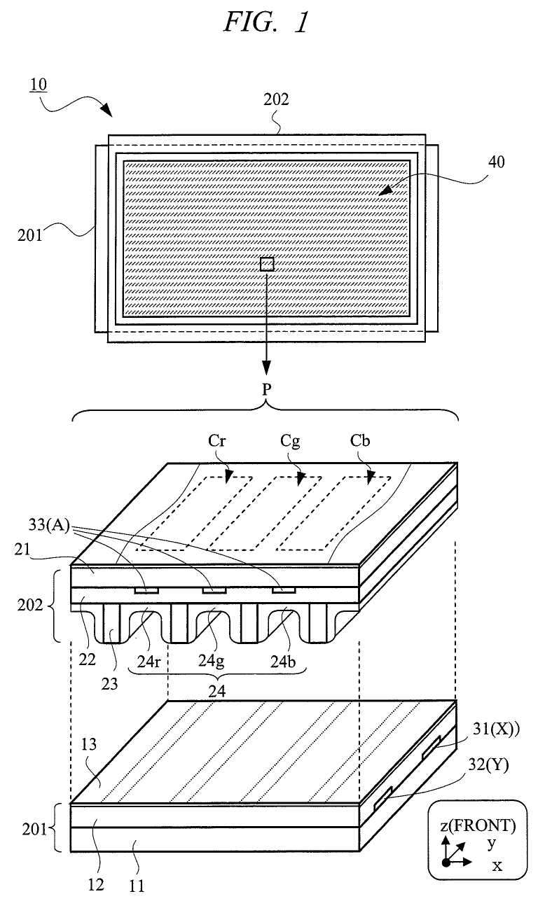

With reference to FIG. 1 to FIG. 3, a PDP 10 of a first embodiment (configuration 1A) of the present invention will be described. The PDP 10 of the first embodiment (configuration 1A) has a configuration in which, as its features, the width (d1) of a bottom surface portion 24-1 of a phosphor layer 24 between barrier ribs 23 of the front unit 202 and the width (d2) of an address electrode 33 are substantially the same (d1≈d2), and when seen from a front surface (display surface) side, and in which the bottom surface portion 24-1 is hidden to be invisible.

<Basic Configuration>

First, in FIG. 1, the PDP 10 serving as a basic structure of the first to seventh embodiments will be descried, and the detailed features thereof will be described later. The PDP 10 of FIG. 1 is a case of an AC-type/surface-discharge and three-electrode (X, Y, A) configuration based on the transmission-type PDP. For purposes of illustration, the PDP 10 has a first direction (x), a second direction (y), and a third direction (z). For a display area (screen) 40 of the PDP 10, the reference symbol x denotes a direction of a horizontally extending display row, the reference symbol y denotes a direction of a vertically extending display column, and the reference symbol z denotes a front-rear direction perpendicular to the panel surface, and the upper side is the front surface (display surface) side, and the lower side is the rear surface side.

The PDP 10 mainly comprises a first substrate structure (rear unit) 201 and a second substrate structure (front unit) 202, which are a substrate structure pair of the front surface side and the rear surface side sandwiching discharge spaces. The display area 40 of the PDP 10 is made of columns of display cells (C). A set of the display cells (Cr, Cg, Cb) corresponding to each color of R (red), G (green), B (blue) in the first direction (x) forms a pixel (P).

The rear unit 201 includes a first glass substrate (rear glass substrate) 11, display electrodes (31, 32), a first dielectric layer 12, and a protective layer 13. A plurality of display electrodes (31, 32) are formed on the first glass substrate 11 (front side) extending in parallel in the first direction (x). The first dielectric layer 12 is formed on the first glass substrate 11 so as to cover the display electrodes (31, 32). Further, the protective layer 13 is formed on the side of a surface exposed in the discharge space on the first dielectric layer 12. The display electrodes (31, 32) comprise a sustain electrode (X) 31 for sustain drive and a scanning electrode (Y) 32 for sustain and scanning drive.

The front unit 202 includes a second glass substrate (front glass substrate) 21, an address electrode (A) 33, a second dielectric layer 22, a stripe barrier rib 23, and phosphors (phosphor layers) 24 {24r, 24g, 24b}. A plurality of address electrodes 33 are formed on the second glass substrate 21 (rear side) extending in parallel in the second direction (y) so as to cross the display electrodes (31, 32). The second dielectric layer 22 is formed so as to cover the address electrode 33 on the second glass substrate 21. The address electrode 33 is aimed for a select drive of displaying (on/off) the display cells (C).

Further, in the present PDP 10, barrier ribs 23, phosphors (phosphor layers) 24, and the like are formed to the front unit 202 side. Areas of the barrier rib 23 and the like are counted to be included in the front unit 202. The barrier ribs 23 are formed in stripes extending along the second direction (y) on the second dielectric layer 22 and between the address electrodes 33. The phosphor layers 24 {24r, 24g, 24b} of respective colors of R, G, and B are, between the barrier ribs 23, formed on the surface of the second dielectric layer 22 corresponding to the address electrode 33 and on the side surfaces of the barrier rib 23. As a structure of the barrier rib 23, other than the striped-shape of the present example, there a box-shape (a structure where the discharge space (S) is comparted per a display cell (C)) and so forth.

The front unit 202 and the rear unit 201 are arranged so as to face each other, and a peripheral part of the substrate thereof are sealed by a seal glass and the like, and a discharge gas, for example, Ne—Xe gas is filled and encapsulated in the space comparted by the barrier ribs 23, thereby to form the PDP 10.

In the PDP 10 of the above structure, when an electric field is applied between the electrodes (31, 32, 33) by a drive from a driving circuit, the discharge gas is excited and ionized, so that vacuum ultraviolet ray is emitted. This emitted vacuum ultraviolet ray hits upon the phosphor layer 24, whereby the corresponding color of the visible light is emitted from the phosphor layer 24. This visible light is utilized for display luminance at the display cell (C) and recognized as luminance by a user. As the discharge, for example, a sustain discharge between the sustain electrode (X) 31 and the scanning electrode (Y) 32, and an address discharge between the scanning electrode (Y) 32 and the address electrode (A) 33 are performed.

Although not illustrated, other than the above-described PDP 10, a PDP module includes a driving circuit for driving an electrode group of the PDP 10 by applying a voltage, a control circuit for controlling the entirety including the driving circuit, and a circuit unit such as a power supply circuit, thereby performing an image display to the PDP 10 by drive control of fields and subfields. The rear side of the PDP 10 is fixed to a chassis, and a rear side of the chassis includes a mounting regions for the circuit unit and the like.

<Cross-Section>

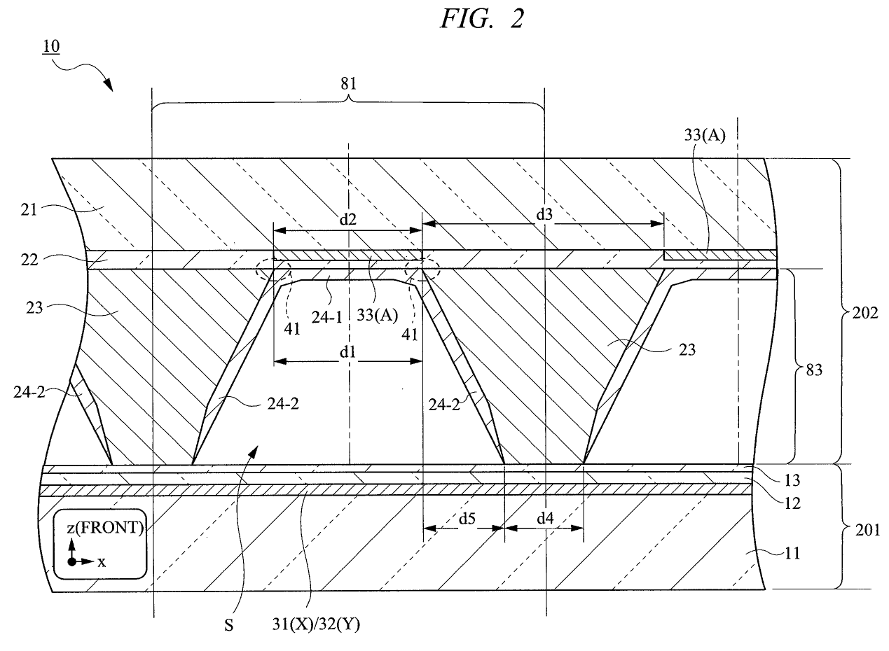

Next, FIG. 2 shows a cross-sectional structure (x-z cross section) of the PDP 10 of the first embodiment (configuration 1A) according to the present invention. FIG. 2 shows a unit emission area 81 corresponding to a single display cell (C). The unit emission area 81 is a light emission area at the center of the address electrode 33. An inter-substrate area (discharge space area) 83 is an area of the discharge space (S), the barrier rib 23, and the like between the front unit 202 and the rear unit 201. The thicknesses of the first glass substrate 11 and the second glass substrate 21 are actually larger as compared with the inter-substrate area 83. FIG. 2 also shows a cross section at the display electrodes (31, 32) (for example, bus electrodes thereof).

The address electrode 33 and the second dielectric layer 22 are formed to the rear surface of the second glass substrate 21 of the front unit 202. The display electrodes (31, 32), the first dielectric layer 12, and the protective layer 13 are formed to the front surface of the first glass substrate 11 of the rear unit 201. The barrier ribs 23 are formed to the front unit 202 by, for example, sandblasting and the like. Between the barrier ribs 23, the phosphor layer 24 is formed by application and the like. The phosphor layer 24 includes a bottom surface portion 24-1 and a side surface portion 24-2. The bottom surface portion 24-1 is formed on a surface of the second dielectric layer 22 corresponding to the address electrode 33 of the front unit 202. The side surface portion 24-2 is formed on side surfaces of the barrier rib 23. A filter and the like can be provided to the front most surface of the front unit 202 as described later.

To increase the emission efficiency as the transmission-type PDP, for example, the barrier rib 23 is made translucent to the discharge emission. That is, optical transmittance is added to light diffusion characteristics in some degree, thereby improving the light guiding efficiency toward the front (specifically, a filler such as alumina, or titania is added). Further, the phosphor layer 24 in preferable to be designed in thickness so as to have predetermined optical transmittance. The emission (visible light) from the phosphor layer 24 by the sustain discharge at the display cell (C) is transmitted by the barrier rib 23, the second glass substrate 21, and the like and passes toward the front surface side, thereby contributing as luminance of the display in the unit emission area 81.

The width (length in the x direction) of the bottom surface portion 24-1 of the phosphor layer 24 between the barrier ribs 23 is taken as d1. In other words, d1 is a length between adjacent end portions 41 of the barrier ribs 23. The width (length in the x direction) of the address electrode 33 is taken as d2. The barrier rib 23 has a substantially trapezoidal cross section, and the width (length of the lower side) of the larger bottom surface of the front unit 202 side is taken as d3, and the width (length of the upper side) of the smaller bottom surface of the rear unit 201 side is taken as d4. The side surface of the barrier rib 23 has an inclined portion due to the difference between the upper side (d4) and the lower side (d3) of the trapezoid. A length in the x direction of this side surface portion of the barrier rib 23 is taken as d5.

Note that, in a case where the barrier rib 23 is formed on the substrate of the front unit 202 by sandblasting and the like, like the present embodiment (FIG. 2), the inclination of the side surface of the barrier rib 23 occurs. The inclination of the barrier rib 23 may be considered to be substantially close to perpendicular (d5<d4) as shown in FIG. 1.

The barrier rib 23 includes the end portion (side) 41 in the width (d3) seen from the front surface side. This end portion 41 is also an end portion of the bottom surface portion 24-1 of the phosphor layer 24. This is a configuration where the width (d2) of the address electrode 33 is made approximately the same as the width (d1) of the bottom surface portion 24-1 of the phosphor layer 24 (d1≈d2), so that the bottom surface portion 24-1 of the phosphor layer 24 is hidden to be invisible when seen from the front surface side.

<Planar Surface>

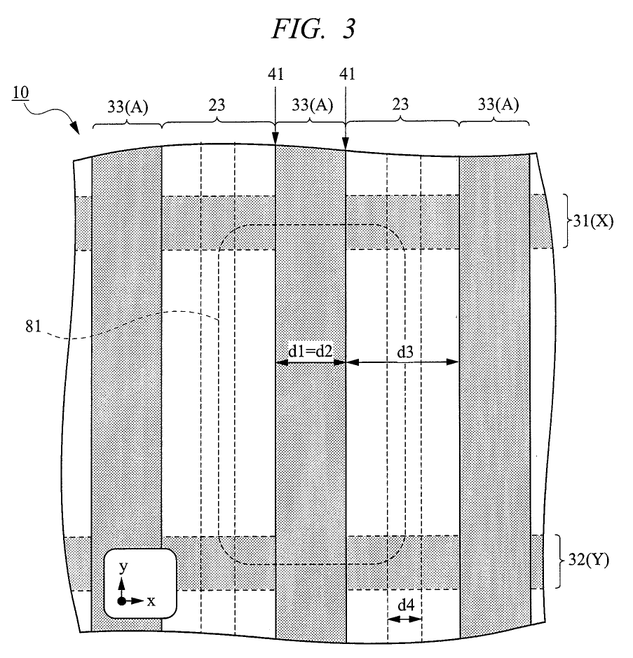

In FIG. 3, corresponding to FIG. 2, a planar structure of the display surface of the front unit 202 side is shown. A schematic arrangement structure of each electrode (31, 32, 33), the barrier rib 23, and the like corresponding to the unit emission area 81 are also shown. The address electrode 33, for example, is linear, and made of metal. Although the display electrodes (31, 32) are shown by only bus electrodes in linear-shape and made of metal for easy description, they may include a transparent electrode and an auxiliary electrode in various shapes. When seen from the unit emission area 81, the emission (for example, visible lights of R) of the display cell (C) comes out to the display surface side by passing through the area of each barrier rib 23 on both sides of the address electrode 33.

According to the first embodiment (configuration 1A), since the diffuse reflection of the phosphor layer 24, particularly that of the bottom surface portion 24-1 is mostly suppressed by blocked by the address electrode 33, the diffusion reflectance (B) of the panel (PDP 10) can be smaller. That is, the contrast can be enhanced, and the set performance of the panel can be improved.

### Second Embodiment (Configuration 1B)

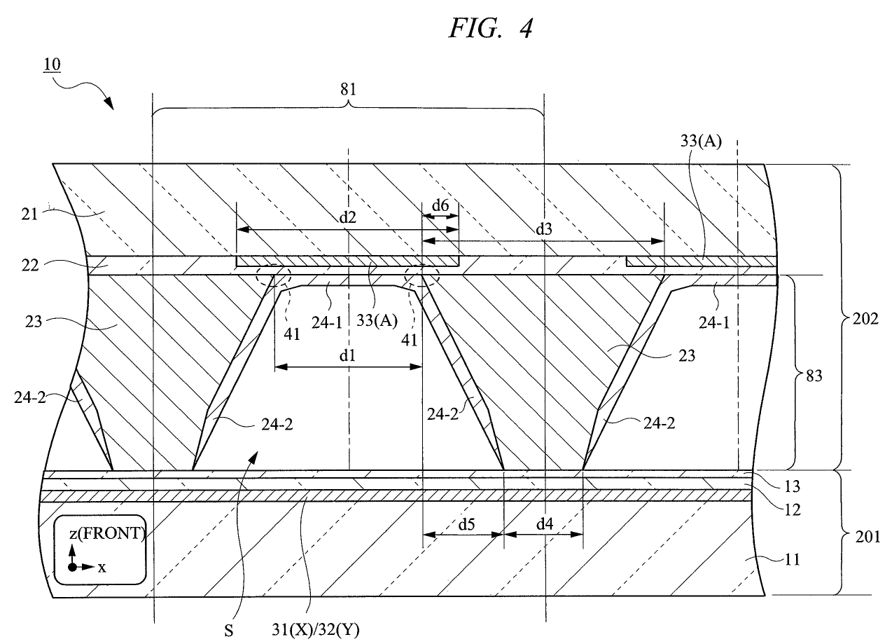

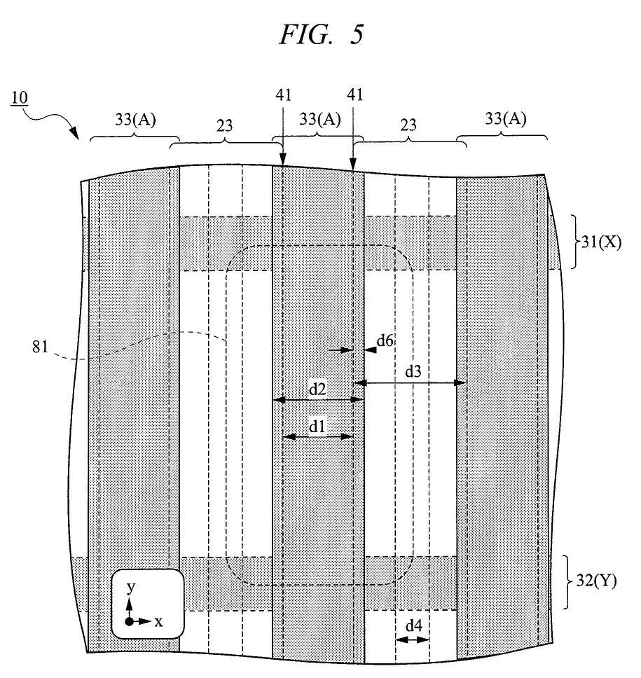

Next, FIG. 4 shows a cross sectional structure (x-z cross section) of the PDP 10 of a second embodiment (configuration 1B) of the present invention. In FIG. 5, corresponding to FIG. 4, a planar structure on the display surface of the front side portion 202 side is shown similarly to FIG. 3. The PDP 10 of the second embodiment (configuration 1B) has a configuration in which, as its features, the width (d2) of the address electrode 33 is slightly made larger than the width (d1) of the bottom surface portion 24-1 of the phosphor layer 24 between barrier ribs 23 in the front unit 202 (d1<d2). And, when seen from the front surface side, not only the bottom surface portion 24-1 of the phosphor layer 24 but also the end portion 41 of the barrier rib 23 is hidden to be invisible. As a result, it is possible to deal with the unevenness on the display surface due to the barrier rib 23 (unevenness of the formation).

In FIG. 4 and FIG. 5, the end portion (side) of the width (d2) of the address electrode 33 is above the end portion 41 of the width (d3) of the barrier rib 23, and a portion of a predetermined length (taken as d6) is superposed. In the present embodiment (FIG. 4 and FIG. 5), this length (d6) of the end portion (superposed portion) of the address electrode 33 is within a range of the length (d5) in the x direction of the side surface of the barrier rib 23. It is only necessary to properly secure this length (d6) in consideration of the degree of the unevenness upon the formation of the barrier rib 23. When the inclination of the side surface of the barrier rib 23 is large, the end portion (d6) of the address electrode 33 may be configured to cover the upper side of the range (d5) of the side surface of the barrier rib 23 (d6≧d5). Further, by making the barrier rib 23 translucent, a configuration can be considered such that the side surface portion 24-2 of the phosphor layer 24 can be also seen from the front surface side through the barrier rib 23. In this manner, when the influence of the side surface portion 24-2 of the phosphor layer 24 is also taken into consideration, it is only necessary to make the width (d2) of the address electrode 33 as d6≧d5 as described above so as to hide also the side surface portion 24-2.

According to the second embodiment (configuration 1B), in addition to the same effect as the first embodiment (configuration 1A), even when the commonly practiced manufacturing method (conventional art) of the panel (PDP 10) is used, the unevenness of the display surface due to the barrier rib 23 can be reduced or prevented, thereby improving the display quality. The details thereof are as follows. The abovedescribed manufacturing method is for forming the barrier rib 23 by sandblasting and the like and forming the address electrode 33 by patterning of metal electrodes (sputtering, etching) and the like. According to the abovesaid manufacturing method, rather than the barrier rib 23, the address electrode 33 can be formed better with less unevenness (shift and swing). Consequently, by the configuration in which the end portion 41 of the barrier rib 23 is hidden by the end portion of the address electrode 33, even when unevenness exists in some degree in the end portion 41 of the barrier rib 23, the end portion of the address electrode 33 with relatively few unevenness may be seen on the display surface, and therefore, this is not recognized as the unevenness during the Off time, thereby improving the display quality.

Note that, as for the method of forming the barrier rib 23, the address electrode 33 and the like, other materials and processes than the abovedescribed ones may be used. In each of the above configurations (1A and 1B), though the address electrode 33 has been made linear with a constant width (d2), the address electrode 33 is not limited to this, and can be modified to various types under the condition that the bottom surface portion 24-1 of the phosphor 24 and the end portion 41 of the barrier rib 23 are hidden. For example, to make the display surface look uniform, the shape in a unit of display cell (C) may be made to have a same shape, for example, a pad type (shape having a width getting wider corresponding to the position to cross the scanning electrode 32) may be used.

<Conventional Art Example>

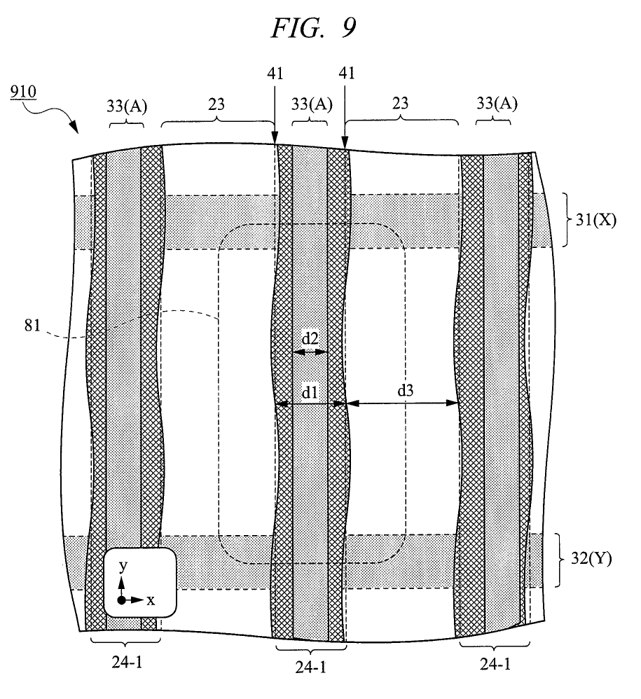

In FIG. 9, with regard to the effects of the first and second embodiments, for purposes of comparison, a conventional art example is shown. In FIG. 9, a conventional PDP (transmission type PDP) 910 has a configuration in which the width (d2) of the address electrode 33 is smaller than the width (d1) of the bottom surface portion 24-1 of the phosphor layer 24 between the barrier ribs 23 (d1>d2). Moreover, it is a case of a configuration where the end portion 41 of the barrier rib 23 is formed by a conventional manufacturing method (sandblasting and the like) not having a complete linear straight side but having an unevenness (shift and swing). For ease of understanding, while a case is illustrated where the unevenness of the end portion 41 extremely exists in a unit of the display cell (C), the same consideration may be taken in a unit of a display column. In this configuration, a part of the bottom surface portion 24-1 can be seen from the display surface side, and the diffuse reflection at the bottom surface portion 24-1 occurs. Further, the end portion 41 of the barrier rib 23 is recognized as the unevenness on the display surface (screen) during the Off time, thereby degrading the display quality. On the other hand, these problems can be solved by applying the configurations of the first and second embodiments.

### Third Embodiment (Configuration 1C)

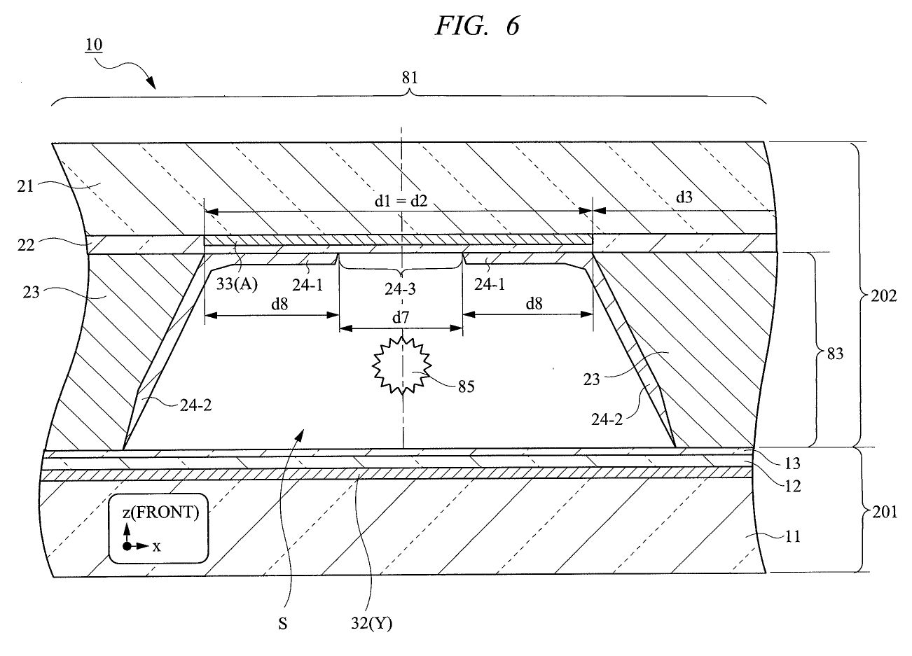

Next, FIG. 6 shows a cross sectional structure (x-z cross section) of the PDP 10 of a third embodiment (configuration 1C) of the present invention. More particularly, a cross section at a scanning electrode (Y) 32 (bus electrode thereof) is shown. The third embodiment (configuration 1C), similarly to the first embodiment and the like, has a configuration in which the bottom surface portion 24-1 of the phosphor layer 24 is hidden by the address electrode 33 (d1≦d2), and moreover, as its features, just below the address electrode 33 and corresponding to an area where the address electrode 33 is crossing the scanning electrode (Y) 32, a part of the bottom surface portion 24-1 of the phosphor layer 24 has a void portion 24-3. For ease of understanding, the length (d1) of the original bottom surface portion 24-1 between the barrier ribs 23 is shown largely.

In the void portion 24-3, particles (phosphor paste) of the phosphor layer 24 are not formed, and the surface (second dielectric layer 22) of the substrate of the front unit 202 side is exposed in the discharge space (S). The width of the void portion 24-3 is taken as d7, and the width of the bottom surface portion 24-1 (connected to the side surface portion 24-2) other than this portion is taken as d8, respectively. As for a method of forming the void portion 24-3, for example, the material of the area (width: d7) of the second dielectric layer 22 corresponding to the void portion 24-3 covering the address electrode 33 is made to repel the phosphor paste, and forming the phosphor layer 24 (24-1, 24-2) by application.

The position to provide the void portion 24-3, in the present embodiment, is at the center of the display cell (C) and the address electrode 33, and corresponds to the area where the address electrode 33 and the scanning electrode 32 are crossing with each other, that is, an address discharge position 85. The address discharge position 85 is a position at which the discharge (address discharge) between the address electrode 33 and the scanning electrode 32 is generated. In the void portion 24-3 which is not blocked by the particles of the phosphor layer 24, the address discharge is easy to generate. In other words, the drive voltage regarding the discharge can be reduced, thereby making the drive easy, and thus it leads to a lower cost of the circuit portion.

### Fourth Embodiment

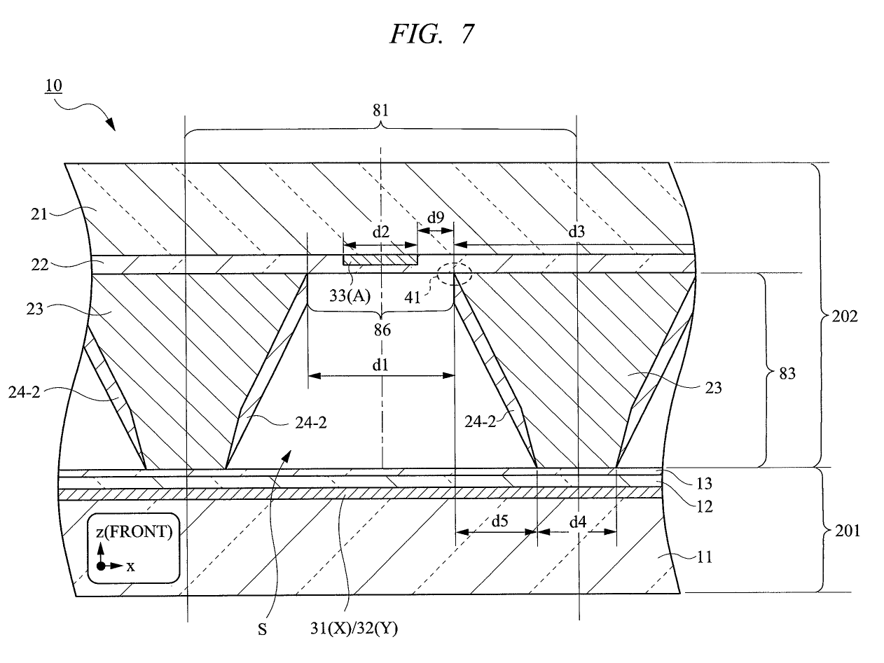

Next, FIG. 7 shows a cross sectional structure (x-z cross section) of the PDP 10 of a fourth embodiment of the present invention. For the purpose of suppressing the diffuse reflection by the phosphor layer 24, different from the first, second, and third embodiments (configurations to make the width (d2) of the address electrode 33 large), the fourth embodiment has a configuration in which, as its feature, the bottom surface portion 24-1 of the phosphor layer 24 is not provided. More particularly, in the inter-substrate area 83 corresponding to the discharge space (S), the fourth embodiment has a configuration in which the bottom surface portion 24-1 is not formed to the surface (second dielectric layer 22) of the front unit 202 side between barrier ribs 23 corresponding to the address electrode 33, but is formed only to the side surface of the barrier rib 23 as the side surface portion 24-2.

It is a configuration where the width (d2) of the address electrode 33 may be made to be smaller than the width (d1) between the barrier ribs 23 as before. In the area 86 at the front surface side between the barrier ribs 23, the particles (phosphor paste) of the phosphor layer 24 are not formed, and the surface (second dielectric layer 22) of the substrate of the front unit 202 side is exposed in the discharge space (S). The length between the end portion 41 of the barrier rib 23 and the end portion of the address electrode 33 in the difference between the width (d1) of the area 86 and the width (d2) of the address electrode 33 is taken as d9. The function of the emission at a display cell (C) is taken by the side surface portion 24-2.

According to the fourth embodiment, when seen from the front surface side, the phosphor layer 24 is not visible from the area (d9) and the like between the end portion 41 of the barrier rib 23 and the end portion of the address electrode 33, and this makes it possible to completely eliminate the diffuse reflection conventionally occurred by the bottom surface portion 24-1 of the phosphor layer 24.

### Fifth Embodiment

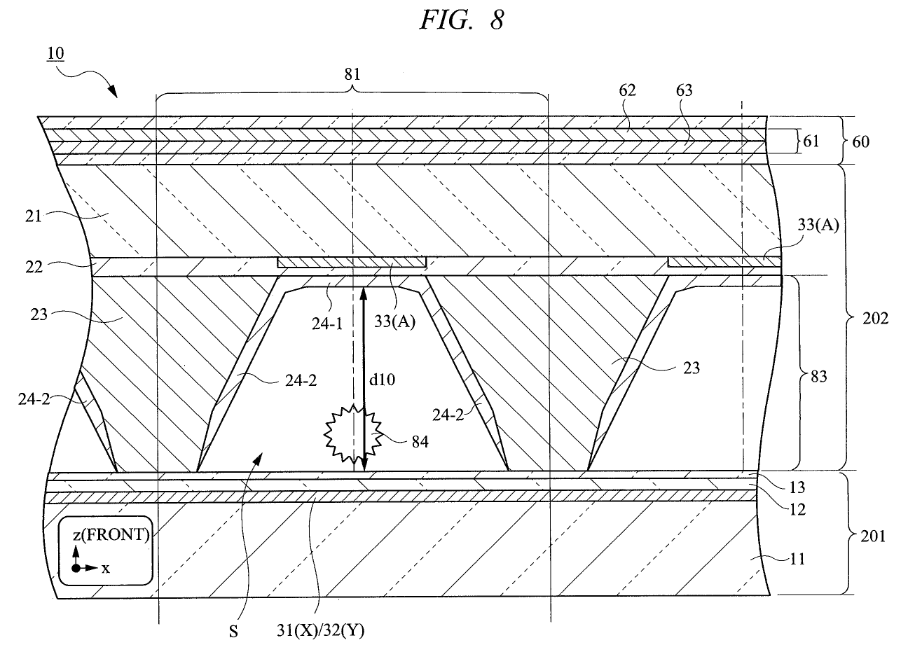

Next, FIG. 8 shows a cross sectional structure (x-z cross section) of the PDP 10 of a fifth embodiment of the present invention. The fifth embodiment has a configuration in which, in addition to the same configuration as the first embodiment (configuration 1A) and the like, as its feature, the front surface of the front unit 202 (second glass substrate 21) is adhered with a film (film-shaped) filter (directly-attached filter) 60 including a polarizing element 61. It is a configuration where the film-shaped filter 60 includes the polarizing element 61 having a function of suppressing outside light reflection (in other words, an outside-light-reflection suppression layer), and it does not include the conventional shield or absorption layer of near infrared ray.

In the PDP 10 (transmission type PDP) of each of the abovedescribed embodiments, a diffuse reflection component due to the phosphor layer 24 (bottom surface portion 24-1) is substantially eliminated, and with regard to the outside light reflection, a specular reflective component becomes a main component. In other words, the PDP 10 described above is substantially specular reflective and has properties of being polarized and maintained. Further, the PDP 10 described above has properties of the near-infrared shield (absorption) due to the absorptive action in a discharge space (S). The PDP 10 of this fifth embodiment has a configuration in which, by utilizing these properties, the above film filter 60 is provided.

The front surface of the second glass substrate 21, across the whole surface corresponding to the display area 40, is adhered with the film filter 60. The polarizing element 61 includes a linear polarization layer 62 and a quarter circular polarization layer 63. In the polarizing element 61, the linear polarization layer (plate) 62 linearly polarizes a visible light. The quarter circular polarization layer 63 one-quarter (90 degrees) circular-polarizes a visible light. Other layers than the polarizing element 61 in the film filter 60 are an adhesive layer and other optical functional layers, and the like. The polarizing element 61 may be provided to further front surface side than the predetermined filter.

A sustain discharge position 84 shows a position of the sustain discharge between the sustain electrode (X) 31 and the scanning electrode (Y) 32. The sustain discharge position 84 is shifted to the rear unit 201 side, and the bottom surface portion 24-1 of the phosphor layer 24 is at the front unit 202 side. A length of the inter-substrate area 83 corresponding to the discharge space (S) in the z direction is taken as d10.

The action of the outside light reflection suppression using the polarizing element 61 is as follows. The incident outside light from the front surface (display surface) side is first linearly polarized by the linear polarization layer 62, and is further circular-polarized one-quarter (90 degrees) by the quarter circular polarization layer 63. The light is substantially specularly reflected by the nature of the present panel itself (except the film-shaped filter 60). The specular reflection light is further circular-polarized one-fourth (90 degrees) by the quarter circular polarization layer 63. That is, the light is circular-polarized one-half (180 degrees) in total. Consequently, the light does not escape from the linear polarization layer 62 to the front surface side, thereby suppressing the outside light reflection.

In the PDP (reflection-type PDP) of the conventional art example, according to the experiments conducted by the inventors of the present invention, since the polarized nature (polarization maintenance stability) is lost by the diffuse reflection at the panel (phosphor), even when the equivalent of the polarizing element 61 is provided on the front surface, there was no effects of the outside light reflection suppression and improvement of the contrast obtained. For example, in the field of the liquid crystal, there is a technique of the equivalent of the polarizing element 61. On the other hand, in the present PDP, by using the panel having substantially specular reflectivity maintaining the polarization and the polarizing element 61, the outside light reflection is largely reduced/prevented, thereby enhancing the contrast and thus the set performance of the panel can be increased.

Further, in the PDP of the conventional art example, a near infrared ray shield (absorption) layer is provided to the filter (directly-attached filter and the like) of the front surface side, so that it deals with the effect of the near infrared ray. On the other hand, since the PDP 10 of the present invention has the nature of the panel substantially shielding (absorbing) the near infrared ray, the function of the near infrared ray shield (absorption) can be realized without providing the near infrared ray shield (absorption) layer to the film filter 60 of the panel front surface side, and it has advantages that the cost is low, and the resistance to moist and heat is high.

The nature of the panel substantially shielding (absorbing) the near infrared ray will be described in detail as the following. In general, the near infrared ray is generated due to a discharge gas such as Xe. In the conventional reflection-type PDP, since the display electrode is at the front surface side, the near infrared ray from Xe and the like is not absorbed, and comes out to the front surface side. The near infrared emission affects, for example, a remote controller and the like, and therefore, a countermeasure is required. Conventionally, the near infrared ray has been cut by the near infrared ray shield (absorption) layer from among the filters at the panel front surface side. However, the near infrared absorbing pigment used for the filter has a disadvantage that the cost is high, and the resistance to moist and heat is low (and in addition, the transmittance of blue color is reduced on a long term basis).

On the other hand, in the configuration of the present PDP 10 (transmission-type PDP), in the inter-substrate area 83 corresponding to the discharge space (S) filled with a discharge gas such as Xe, the sustain discharge (surface discharge) between the sustain electrode (X) 31 and the scanning electrode (Y) 32 is generated close to a surface (protective layer 13) of the display electrodes (31, 32) side of the rear unit 201 (at the sustain discharge position 84). The near infrared ray emitted from the discharge plasma transmits through the discharge gas (Xe) for long. In the discharge space (S), since the distance (d10) is relatively long, the near infrared ray emitted from Xe is absorbed again by Xe in the midst of heading to the front surface side. As a result, in the present PDP, the panel itself has the nature of mostly shielding (absorbing) the near infrared ray.

In the foregoing, the invention made by the inventors of the present invention has been concretely described based on the first to fifth embodiments. However, it is needless to say that the present invention is not limited to the foregoing embodiments and various modifications and alterations can be made within the scope of the present invention.

The present invention is applicable to a PDP device.

What is claimed is:

1. A plasma display panel comprising first and second substrate structures sandwiching a discharge space for encapsulating a discharge gas, in which a cell group is configured by an electrode group,
wherein the first substrate structure includes a display electrode pair extending in a first direction to a first glass substrate,
wherein the second substrate structure includes an address electrode extending in a second direction to a second glass substrate,
wherein the first substrate structure is arranged on a rear surface side, and the second substrate structure is arranged on a front surface side,
wherein the second substrate structure includes barrier ribs formed by extending at least in the second direction so as to divide the discharge space, and phosphor layers of respective colors formed between the barrier ribs and exposed in the discharge space,
wherein the barrier rib is translucent to the light emission from the phosphor,
wherein the phosphor layer includes a bottom surface portion formed on a surface corresponding to the address electrode of the second substrate structure side, and
wherein a width of the address electrode in the cell is substantially same as a width of the bottom surface portion of the phosphor layer between the barrier ribs, and the bottom surface portion of the phosphor layer is hidden by the address electrode.

2. A plasma display panel comprising first and second substrate structures sandwiching a discharge space for encapsulating a discharge gas, in which a cell group is configured by an electrode group,
wherein the first substrate structure includes a display electrode pair extending in a first direction to a first glass substrate,
wherein the second substrate structure includes an address electrode extending in a second direction to a second glass substrate,
wherein the first substrate structure is arranged on a rear surface side, and the second substrate structure is arranged on a front surface side,
wherein the second substrate structure includes barrier ribs formed by extending at least in the second direction so as to divide the discharge space, and phosphor layers of respective colors formed between the barrier ribs and exposed in the discharge space,
wherein the barrier rib is translucent to the light emission from the phosphor,
wherein the phosphor layer includes a bottom surface portion formed on a surface corresponding to the address electrode of the second substrate structure side, and
wherein a width of the address electrode in the cell is larger than a width of the bottom surface portion of the phosphor layer between the barrier ribs, and the bottom surface portion of the phosphor and an end portion of the barrier rib are hidden by the address electrode when seen from the front surface side.

3. The plasma display panel according to claim 1,
wherein the bottom surface portion of the phosphor layer has a void portion where the phosphor layer is not formed in a part of the bottom surface portion corresponding to an area crossing a scanning electrode of the display electrode pair in a lower side of the address electrode, thereby exposing a surface of the second substrate structure side.

4. The plasma display panel according to claim 2,
wherein the bottom surface portion of the phosphor layer has a void portion where the phosphor layer is not formed in a part of the bottom surface portion corresponding to an area crossing a scanning electrode of the display electrode pair in a lower side of the address electrode, thereby exposing a surface of the second substrate structure side.

5. A plasma display panel comprising first and second substrate structures sandwiching a discharge space for encapsulating a discharge gas, in which a cell group is configured by an electrode group,
wherein the first substrate structure includes a display electrode pair extending in a first direction to a first glass substrate,
wherein the second substrate structure includes an address electrode extending in a second direction to a second glass substrate,
wherein the first substrate structure is arranged on a rear surface side, and the second substrate structure is arranged on a front surface side,
wherein the second substrate structure includes barrier ribs formed by extending at least in the second direction so as to divide the discharge space, and phosphor layers of respective colors formed between the barrier ribs and exposed in the discharge space,
wherein the barrier rib is translucent to the light emission from the phosphor,
wherein the phosphor layer includes a bottom surface portion formed on a surface corresponding to the address electrode of the second substrate structure side, and
wherein the phosphor layer includes a side surface portion formed on a side surface of the barrier rib, and is not formed on the surface corresponding to the address electrode of the second substrate structure side so that, seen from the front surface side, the phosphor layer is not visible.

6. The plasma display panel according to claim 1,
wherein a polarizing element for suppressing outside light reflection having a linear polarization layer and a quarter circular polarization layer is provided to the front surface side of the second glass substrate.

7. The plasma display panel according to claim 2,
wherein a polarizing element for suppressing outside light reflection having a linear polarization layer and a quarter circular polarization layer is provided to the front surface side of the second glass substrate.

8. The plasma display panel according to claim 5,
wherein a polarizing element for suppressing outside light reflection having a linear polarization layer and a quarter circular polarization layer is provided to the front surface side of the second glass substrate.

9. The plasma display panel according to claim 6,
wherein a film-shaped filter including the polarizing element is attached to a front surface of the second glass substrate.

10. The plasma display panel according to claim 7,
wherein a film-shaped filter including the polarizing element is attached to a front surface of the second glass substrate.

11. The plasma display panel according to claim 8,
wherein a film-shaped filter including the polarizing element is attached to a front surface of the second glass substrate.
